(19) United States
(12) Patent Application Publication
(10) Pub. No.: US 2012/0278075 A1
(43) Pub. Date: Nov. 1, 2012

(54) System and Method for Community Feedback and Automatic Ratings for Speech Metrics

(76) Inventors: Sherrie Ellen Shammass, Gedera (IL); Eyal Eshed, Bnei Atarot (IL); Ariel Velikovsky, Modi'in (IL)

(21) Appl. No.: 13/455,156

(22) Filed: Apr. 25, 2012

Related U.S. Application Data
(60) Provisional application No. 61/479,049, filed on Apr. 26, 2011.

(51) Int. Cl. G10L 15/00

(52) U.S. Cl. 704/236; 704/E15.001

(57) ABSTRACT

A system and method for collecting from an ASR, a first rating of an intelligibility of human speech, and collecting another intelligibility rating of such speech from networked listeners to such speech. The first rating and the second rating are weighed based on an importance to a user of the ratings, and a third rating is created from such weighted two ratings.

### CROSS REFERENCE TO RELATED APPLICATIONS

This application claims the benefit of U.S. Provisional Application No. 61/479,049, filed on Apr. 26, 2011, entitled System and Method for Community Feedback and Automatic Ratings for Speakability and Voice Trait Metrics, incorporated by reference in its entirety herein.

### FIELD OF THE INVENTION

This application relates to automated scoring and instruction of oratory arts the speaking arts and in particular to obtaining community ratings and/or automatic ratings of speech, and to evaluating human speech.

### BACKGROUND OF THE INVENTION

Speakers such as native speakers of a first language may speak to listeners in a second language where such listeners are native speakers of a third language. Such cross-linguistic and cross-cultural situations as well as other situations may require overcoming problems of mutual intelligibility and speaking appropriateness. Furthermore, a speaker may be fully understood and perceived well by some populations, but not understood or perceived well by others. For example, a Chinese speaker may be understood by fellow Chinese English learners, but be unintelligible to native English speakers.

### SUMMARY OF THE INVENTION

Embodiments of the invention may include a method for rating an intelligibility of human speech. A method may include collecting a first intelligibility rating of the human speech from an automated speech recognition system, collecting a second intelligibility rating of the human speech from human listeners to the human speech; and combining the first rating and the second rating by weighing an importance of each rating and producing produce a third rating. In some embodiments the human speech may recorded and provided to human listeners over a network. Human listeners may provide ratings and comments on the speech over the network.

In some embodiments a signal from a user as to a value of a weighting of the first rating and second rating may be accepted, and the combining of the ratings may include the accepted values.

In some embodiments, a user may input a requirement of a characteristic of human listeners, and the system may accept or select human listeners who satisfy or match such requirement.

Is some embodiments, a weighting of the first and second ratings may be assigned from a satisfaction of pre-defined thresholds, for example if a minimum number of human listeners are not available, a weighting of an ASR evaluation may be more heavy or maximized.

Embodiments of the invention may include a system having a memory to collect and store a intelligibility rating of a human speech produced by an automated speech recognition system and an intelligibility rating produced by human listeners to the human speech. The system may include a processor to factor the ratings by an importance weighting of the first rating and the second rating, and to generate a third intelligibility rating based on the factored ratings.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a system including a sound reproduction device, a sound input device, a processor, a memory and a display in accordance with an embodiment of the invention;

FIG. 2 is a table showing various possible weights assigned to ratings produced by an automated speech recognition system and ratings produced from inputs from community-based feedback, in accordance with an embodiments of the invention; and

FIG. 3 is a flow diagram of a method in accordance with an embodiment of the invention;

### DETAILED DESCRIPTION OF EMBODIMENTS OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored as instructions on an article such as a memory device, where such instructions upon execution by a processor result in a method of an embodiment of the invention.

As used in this application, the term ‘community’ may, in addition to its regular meaning, include one or more human listeners who may listen to a human speech or a recording of a human speech that may have been transmitted to them over or by way of a network connection. Such listeners may listen to the recorded speech either synchronously or asynchronously.

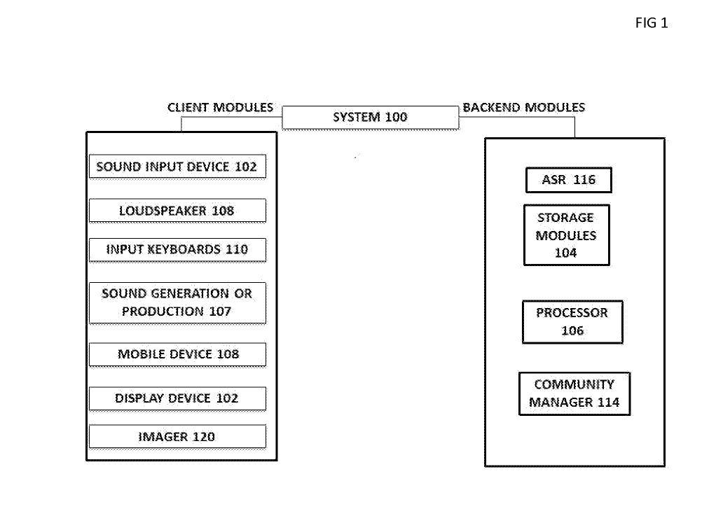

Reference is made to FIG. 1, a schematic diagram of a system including a sound reproduction device, a sound input device, a data input device, a processor, a memory and a display in accordance with an embodiment of the invention. System 100 may include a sound input device such as a microphone 102 or other voice recording mechanism such as a voice recording mechanism on a mobile device, one or more mass data storage modules such as a memory 104, a processor 106 such as a central processing unit that may be associated with memory 104, a sound generation or reproduction unit such as headphones or a loudspeaker 107 or a loudspeaker from a mobile device 108, a data input device 110 such as a keyboard or mobile phone key functions 110, a display device such as a monitor or screen or a mobile screen 112 and an imager 120. Various software packages or modules may be stored on memory 104 or elsewhere, and may be associated with processor 106. Such packages or modules may be executed by one or more processors 106 that may be or include cloud-based processors to carry out some or all functions of an embodiment of the present invention.

In some embodiments, a software package executed as part of an embodiment of the invention such as by processor 106, may include an automated speech recognition (ASR) 116 engine package that may identify spoken words or utterances. ASR 116 may also evaluate various qualities of spoken words such as diction, accent, dialect, speed, inflection, emotion, as well as the severity and frequency of various speech or pronunciation problems. ASR 116 as may be suitable for use in embodiments of the invention may include those available from for example SRI International, CMU Robust Speech Recognition, and Nuance. Other ASR 116 engines may be used.

In some embodiments, software executed in the course of an embodiment of the invention, may include a management module 114 that may collect, analyze, evaluate, assess, provide threshold values, categorize or score various types of input data available to system 100 including feedback provided by ASR 116, as well as ratings from one or more listeners who may be part of the community of listeners to a human speaker. Such ratings as may be submitted by a listener who hears the speaker over a network connection may include or be associated with time and date parameters, geographical or location information of the listener, past history of the listener in evaluating a human speaker and other factors. Packages that may be suitable for use as management module 114 may include those available from learning management systems (LMS). [is this a trade name? if so, please provide full name of the company and product].

In operation, verbal speech from a human speaker or from a recording of a human speaker as may have been recorded using microphone 102 and/or as may have been stored on memory 104, may be input into ASR 116. ASR 116 may identify the spoken words or speech, and evaluate one or more qualities of the identified words, syllables or other human spoken sounds. In some embodiments such qualities may include diction, pronunciation, voice modulation, pitch, tone, emphasis, emotion speed or rate of speech, intelligibility or other characteristics of a speaker's speech. ASR 116 may assign one or more ratings to one or more of such qualities. ASR 116 may present the speaker with feedback such as one or more comments, criticisms, scores or evaluations of a quality of the identified, recorded or spoken words. Such feedback, comments or evaluations may be presented by way of for example loudspeaker 107, screen 112 or other device to the speaker or to other community members.

The speaker's words may also be provided to for example over a network to listeners who may choose to participate as a community in providing a rating of one or more of the qualities of the speech of the human speaker. Using their own input devices 110, listeners may rate the speaker's words for diction, pronunciation, voice modulation, pitch, tone, emphasis, emotion speed or rate of speech, intelligibility or other characteristics of a speaker's speech or for impressions of the speaker, such as if the speaker sounds sincere, authoritative, trustworthy or other speaking traits or delivery qualities. Such ratings may be transmitted for example over a network connection to for example management module 114.

Ratings from ASR 116 as well as those submitted by members of the community of listeners may be gathered and weighted by the manager module 114, and such gathered and weighted information may provide intelligibility metrics or other feedback scores to the speaker. Such combined or weighted scores may include one or more comments, criticisms or evaluations of a quality of the identified, recorded or spoken words. Management module 114 may also store or collect data about one or more of the speaker and one or more members of the community, such as geographic location, native language, fluency of one or more languages, time of day, frequency of use or other speaker or listener behaviors or other information. Speaking traits of a speaker, or characteristics of a listener who may be part of a community may also be collected, based on for example geographic or other criteria. In some instances, ratings may be collected for an intelligibility of a speaker by audiences who are in a particular country. For example, scores may be provided for a French speaker speaking in English, as understood and rated by Chinese listeners, and such scores may be compared to the intelligibility of the speaker as understood and rated by Nigerian listeners.

In some embodiments, ASR 116 may detect levels of ability of a speaker or speech, and areas that need additional repetition and instruction.

In some embodiments, community ratings analyses may provide scoring feedback of the speaker's ability and provide suggestions of areas that need additional repetition and instruction.

In some embodiments, information stored in for example 104 may be analyzed to provide threshold based scoring decisions of the speaker's abilities based on factors such as geographic location of the speaker and/or community members, time of day, speaker behavior, past speaker performance or other analytics or analysis. For example, management module 114 may determine that a speaker's speech is so unintelligible as to not warrant distribution to possible members of a community of listeners. Management module 114 may determine that a noise level or other characteristic of a recording by a speaker is above a pre-defined level and that ASR ratings of the speech are not to be used in providing feedback to a listener.

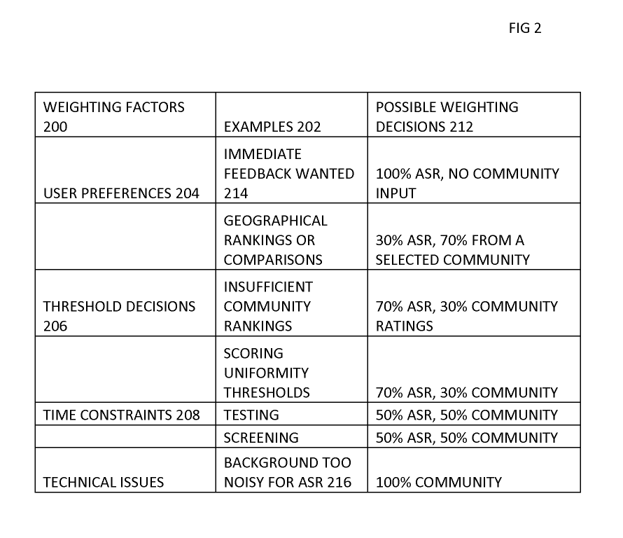

Reference is made to FIG. 2, a table of weights assigned to ratings produced by an automated speech recognition system and ratings produced from inputs from community-based feedback, in accordance with an embodiments of the invention. Columns 200 and 202 may include factors that may influence or dictate a weighing of ASR ratings and community based ratings, and example of such factors. Such factors as in cells 204, 206, 208 and 210 may include a user preference for weighing as may be input by a user into for example management module 114, various threshold decisions such as a sufficiency or insufficiency of listeners who may have joined a listening community and heard a speaker's speech, time constraints such as a desire for immediate feedback, or other technical considerations. Column 212 may include possible weightings that may be assigned to each of ASR ratings and to community based ratings, in light of the preferences or constraints included in columns 200. For example, as in cell 214, a user's need for immediate feedback may dictate that no community feedback will be available, and that the community feedback weight should be zero. In cell 216, too much background noise in a recording may make ASR ratings impossible such that community ratings alone are considered when providing feedback to the user. Other factors and weights are possible.

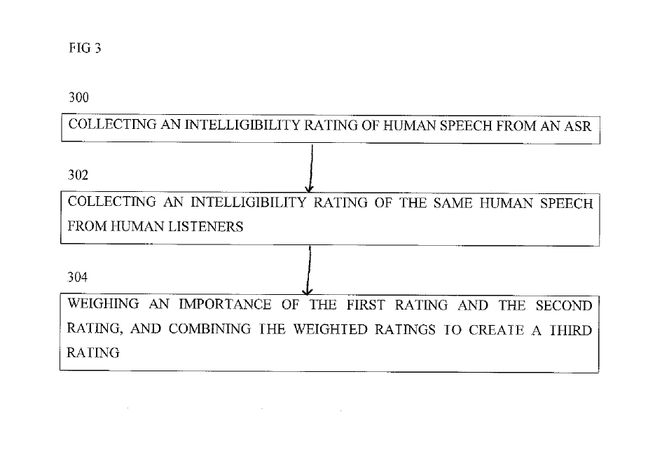

Reference is made to FIG. 3, a flow diagram of a method for rating an intelligibility of human speech, may include as in block 300, collecting a first intelligibility rating of the human speech from an automated speech recognition system. In block 302 of a method, there may be collected a second intelligibility rating of the same human speech from one or more human listeners who listened to the human speech and provided feedback, ratings or comments on qualities of the human speech. In block 304, the first rating may be combined with the second rating, and one or more of the ratings on one or more of the qualities may be weighted in accordance with stored criteria to produce a third rating. One or more of the first rating, the second rating and the third rating may be provided to a user.

In some embodiments, a method may include recording the human speech, and providing network access to the recorded human speech to the human listeners. Ratings from the human listeners may be collected and transmitted over the network.

In some embodiments, a signal may be accepted from a user as to a value or weighting that is be assigned to the first rating, and a value or weighting that is to be assigned to the second rating. Combining the ratings may include weighting the first rating and the second rating by the values or weights that were accepted from the user.

In some embodiments, a method may include accepting from a user an indication of a characteristic of the human listeners who may be included in the community, and then selected or accepting listeners who match the indication. For example, a user may want to know if his speech is intelligible to French speakers. A system would then select and accept only French listeners as part of the community of listeners. In some embodiments, a weighting of first rating or a second rating may be minimized or maximized to meet a pre-defined threshold, or if a rating fails to meet a pre-defined threshold. For example, if noise on a recorded speech brings the accuracy of an ASR rating below a pre-defined threshold, the weighting of the ASR ratings may be minimized. Similarly, if there are no or too few listeners in a community who submitted a rating of a speech or none or too few of the listeners in a community who meet a given qualification requested by a user, the weighting of the community rating may be minimized.

In some embodiments, feedback can be provided to the user in an offline system such as a learning management system for suggestions of areas that need additional repetition and instruction or suggestions of course levels, learning flows or practice methods. In some embodiments, the suggestions for areas that need additional repetition and instruction or suggestions of course levels, learning flows or practice methods may be provided if the human speech is below a pre-defined level or threshold.

Some embodiments of the invention may be implemented, for example, using an article including or being a non-transitory machine-readable or computer-readable storage medium, having stored thereon instructions, that when executed on a computer, cause the computer to perform method and/or operations in accordance with embodiments of the invention. The computer-readable storage medium may store an instruction or a set of instructions that, when executed by a machine (for example, by a computer, a mobile device and/or by other suitable machines), cause the machine to perform a method and/or operations in accordance with embodiments of the invention. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Video Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method for rating an intelligibility of human speech, comprising:
collecting a first intelligibility rating of said human speech from an automated speech recognition system;
collecting a second intelligibility rating of said human speech from human listeners to said human speech; and
combining said first rating and said second rating by weighing an importance of said first rating and said second rating, to produce a third rating.

2. The method as in claim 1, comprising:
recording said human speech; and
providing network access to said recorded human speech to said human listeners; and
wherein said collecting comprises collecting a plurality of said second
ratings from a plurality of said human listeners over said network.

3. The method as in claim 1, comprising accepting a signal from a user as to a value of said first rating and a value of said second rating, and wherein said combining comprises combining said first rating and said second rating using said accepted value of said first rating and said accepted value of said second rating.

4. The method as in claim 1, comprising:
accepting from a user an indication of a characteristic of said human listeners; and
selecting said users to match said indication.

5. The method as in claim 1, wherein said combining comprises minimizing a weighting of said second rating if said collecting said second rating fails to meet a pre-defined threshold.

6. The method as in claim 5, minimizing said weighting of said second rating if said second rating fails to meet a pre-defined threshold selected from the group consisting of a number of said human listeners from whom said second rating has been collected, and a qualification of said human listeners from whom said second rating has been collected.

7. A system comprising:
a memory to
collect a first intelligibility rating of a human speech, said first rating produced by an automated speech recognition system;
collect a second intelligibility rating of a human speech, said second rating produced by human listeners to said human speech; and
a processor to weigh an importance of said first rating and said second rating, and to generate a third intelligibility rating.

8. The system as in claim 7, wherein said memory is to record said human speech, and said processor is to provide said human listeners with networked access to said recorded human speech.

9. The system as in claim 7, wherein said processor is to accept from a user a characteristic of said human listeners.

10. The system as in claim 9, wherein said processor is to select said human listener only if said characteristic is present in said listener.
